(19) United States
(12) Patent Application Publication
(10) Pub. No.: US 2024/0181986 A1
(43) Pub. Date: Jun. 6, 2024

(54) SEAT BELT BUCKLE UP DETECTION

(71) Applicant: Sandra Blue, Decatur, GA (US)

(72) Inventor: Sandra Blue, Decatur, GA (US)

(21) Appl. No.: 18/072,880

(22) Filed: Dec. 1, 2022

(51) Int. Cl. B60R 22/48; B60N 2/00

(52) U.S. Cl. CPC B60R 22/48; B60N 2/002; B60R 2022/4816; B60R 2022/4875

(57) ABSTRACT

A seat belt detection device includes a first sensor that is configured to detect whether a seat housed in a vehicle is occupied. A second sensor is configured to detect whether a seat belt associated with the seat is latched. An indicator is visible externally from the vehicle. A controller is communicatively coupled to the first sensor, the second sensor, and the indicator, wherein the controller includes circuitry configured to activate the indicator when an occupied seat has an unlatched seat belt.

### BACKGROUND

### Technical Field

The present disclosure generally relates to motor vehicle safety, and more particularly, to seat belt devices.

### Description of the Related Art

Despite the introduction of passive restraint devices such as airbags, every year there are still a significant number of injuries and fatalities from automobile accidents. Both passengers and motorists alike do not always wear a seat belt and/or shoulder harness combination. The National Highway Traffic Safety Administration (NHTSA) estimates that in 2021 compliance with seat belt use was approximately 90.4% on a national level. Of the approximately 23,000 people killed in automobile accidents per year in the U.S., NHTSA estimates approximately 2500 people per year would have been saved with seat belt use.

Municipalities have passed safety regulations mandating seat belt use, and police issue fines to passengers in vehicles who are not belted in. However, detection as to whether or not the motorist and the passengers are complying with the safety regulations remains difficult, as the officer often has to approach the vehicle and confirm noncompliance.

### SUMMARY

In one embodiment, a seat belt detection device includes a first sensor that is configured to detect whether a seat housed in a vehicle is occupied. A second sensor is configured to detect whether a seat belt associated with the seat is latched. An indicator is visible externally from the vehicle. A controller is communicatively coupled to the first sensor, the second sensor, and the indicator, wherein the controller includes circuitry configured to activate the indicator when an occupied seat has an unlatched seat belt.

In an embodiment, the second sensor is configured to detect whether the seat belt associated with the seat is latched in response to the first sensor detecting the seat is occupied.

In an embodiment, the first sensor includes a switch arranged in the seat.

In an embodiment, at least one of the first sensor and/or the second sensor is an optical sensor.

In an embodiment, the indicator is a light within the vehicle that is externally visible.

In an embodiment, the indicator is a light arranged in or an on external surface of the vehicle.

In an embodiment, a light is arranged in or an on external surface of the vehicle.

In an embodiment, the indicator is an existing exterior light of the vehicle.

In an embodiment, the existing exterior light is configured to provide an indication of the unlatched seat belt selected from the group consisting of a brighter output, a flashing output, a change in color, a change in a flashing pattern, or a strobe output.

In an embodiment, the indicator is an interior light of the vehicle, and wherein the controller is configured to flash the interior light on and off when an occupied seat has an unlatched seat belt.

In an embodiment, the indicator is a light selected from the group consisting of a brake light, a turn-signal light, a hazard light, a license plate light, or a fog light.

In an embodiment, the controller is communicatively coupled to the indicator and the first sensor and/or the second sensor by a wireless protocol.

In one embodiment, a method of detecting seat belt wearing includes detecting, by a sensor, a latched status of a seat belt of an occupied seat. A reflector with a light is arranged on a rear bumper of a vehicle. The light is configured to flash when the sensor detects the seat belt is unlatched in an occupied seat.

In an embodiment, a first sensor is configured to detect whether a seat housed in a vehicle is occupied;

In an embodiment, a second sensor is configured to detect whether a seat belt associated with the seat is latched; and an indicator is arranged that is visible externally from the vehicle.

In an embodiment, a controller is communicatively coupled to the first sensor, the second sensor, and the indicator. The controller activates the indicator when an occupied seat has an unlatched seat belt.

In an embodiment, the second sensor is configured to detect whether the seat belt associated with the seat is latched in response to the first sensor detecting the seat is occupied.

In an embodiment, the first sensor is arranged in the seat.

In an embodiment, the arranging of the indicator includes arranging a light within the vehicle that is externally visible.

In an embodiment, the arranging of the indicator comprises arranging a light in or on an external surface of the vehicle.

In an embodiment, the indicator includes an existing exterior light of the vehicle.

In an embodiment, the existing exterior light is configured to provide an indication of the unlatched seat belt selected from the group consisting of a brighter output, a flashing output, a change in color, a change in a flashing pattern, or a strobe output.

In an embodiment, the coupling of the controller to the indicator, the first sensor and/or the second sensor is performed by a wireless protocol.

These and other features will become apparent from the following detailed description of illustrative embodiments thereof, which is to be read in connection with the accompanying drawings.

### BRIEF DESCRIPTION OF THE DRAWINGS

The drawings are of illustrative embodiments. They do not illustrate all embodiments. Other embodiments may be used in addition to or instead. Details that may be apparent or unnecessary may be omitted to save space or for more effective illustration. Some embodiments may be practiced with additional components or steps and/or without all the components or operations that are illustrated. When the same numeral appears in different drawings, it refers to the same or like components or operations.

FIG. 1 illustrates a perspective view of a rear bumper of an automobile having a seat belt detection device according to an illustrative embodiment of the present disclosure.

FIG. 2 is a schematic showing the coupling of a controller and sensors according to according to an illustrative embodiment of the present disclosure.

FIG. 3 is a flowchart providing a non-limiting example of the operation of a seat belt detection device according to an illustrative embodiment of the present disclosure.

### DETAILED DESCRIPTION

### Overview

In the following detailed description, numerous specific details are set forth by way of examples to provide a thorough understanding of the relevant teachings. However, it should be understood that the present teachings may be practiced without such details. In other instances, well-known methods, procedures, components, and/or circuitry have been described at a relatively high level, without detail, to avoid unnecessarily obscuring aspects of the present teachings.

As used herein, the term “seat belt” is to be interpreted broadly and may include a seat belt and should harness combination, or belt that straps around the waste of a passenger, or a shoulder harness.

The term “wireless protocol” includes optical communication (e.g., visible and non-visible), radio communication (e.g., Wi-Fi, Bluetooth, near-field communication, Wibro, WiMAX microwave, FM. etc.).

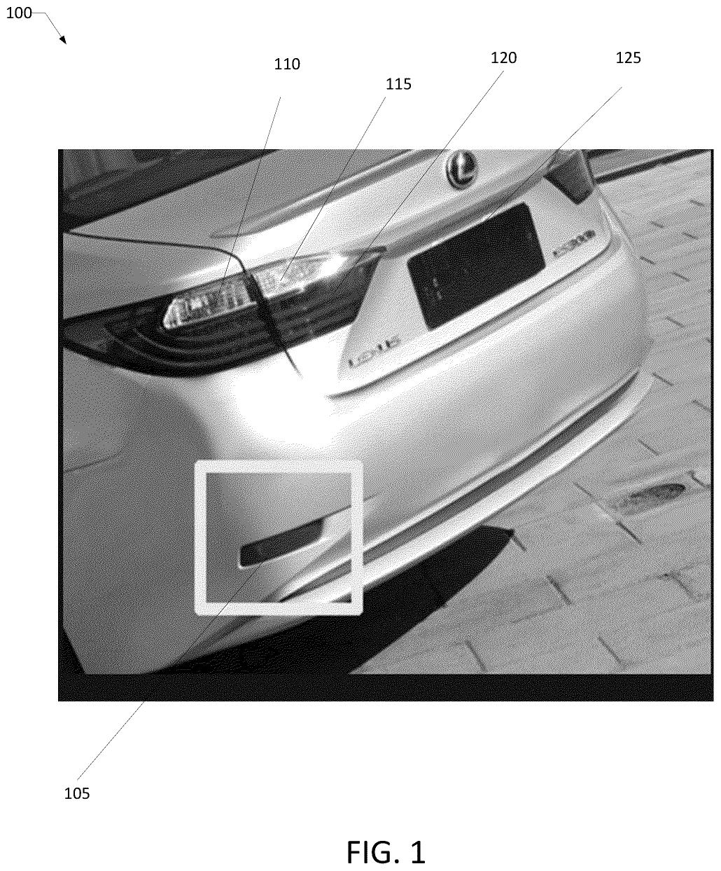

FIG. 1 illustrates a perspective view 100 of a rear bumper of an automobile having a seat belt detection device according to an illustrative embodiment of the present disclosure. A reflector 105 may have a dedicated light, or an existing light of the vehicle, that may be actuated to indicate to persons external to the vehicle that the vehicle has an occupied seat without a seat belt being worn. It is to be understood that any external light may be used to indicate the lack of seat belt wearing. For example, a turn signal 110, a backup light 115, a rear tail light 120 and/or a license plate light 125 may be used. In addition, the brake light that is in the rear window of a vehicle may also be used to indicated that a seatbelt is not being worn.

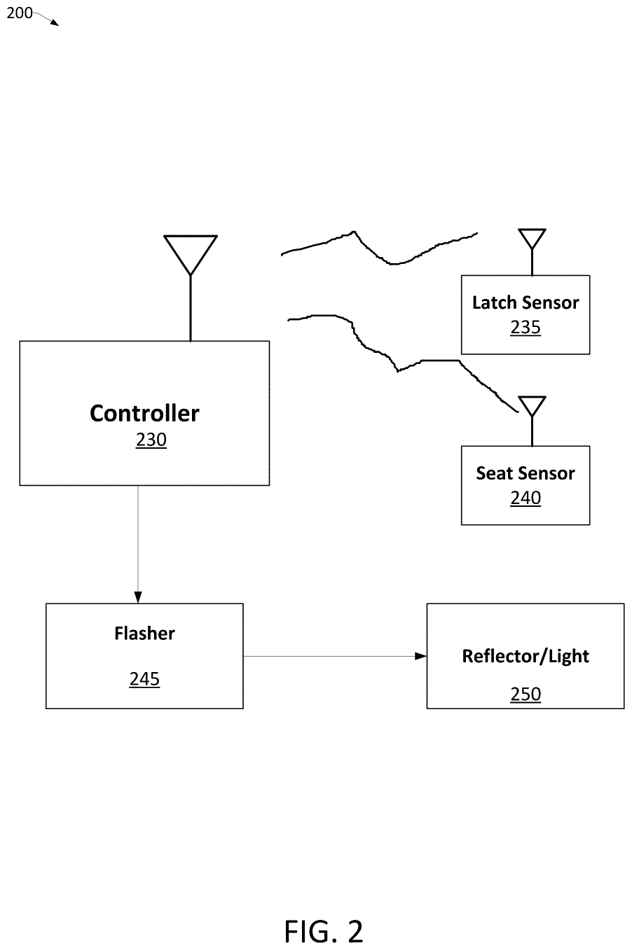

The controller (see FIG. 2) can cause any type of visual indication that a seat belt is not being worn. For example, the color may be different than red (e.g. purple), or the light may flash, the light may flash in a varied sequence, the brightness of the light may vary, the light may project a strobe output, a weird such as “seat belt” may be displayed. The following were just a few of the none visual indications that may show there is no seatbelt being worn. In the present disclosure, an interior light may also turn on and off, or may flash, pulse, or provide a stationary output in a particular/different color than the white light typically used by an interior light. In addition, while the reflector is shown in the rear bumper, the present disclosure is not limited to the rear of the vehicle, and the light may be arranged on the roof of the vehicle.

FIG. 2 is a schematic showing the coupling of a controller and sensors according to according to an illustrative embodiment of the present disclosure. In one illustrative embodiment, the controller 230 may be an optical controller that is used to optically sense the seat is occupied and that the seat belt is connected a receptable when the seat belt is latched. In other illustrative embodiments, the controller may use a wireless protocol such as Bluetooth, WiBro, WiMAX, WIFI, FM, etc. to communication with a latch sensor 235 and a seat sensor 240. The seat sensor 240 may be a pressure sensor installed in the seat. Alternatively, other types of sensors (heat, light, magnetic, etc.) may be used. The latch sensor 235 and the seat sensor 240 may have antennas to wireless send a status to the controller 230 that the sea is occupied (or not), and that a latched seatbelt is sensed.

With continued reference to FIG. 2, the controller 230 may signal a flasher 245 to acuate the reflector/light 250. It is to be understood that the flasher 245 may be incorporated into the controller 230, and the vehicles computer may include the controller 230. The connections between all of the elements shown in FIG. 2 may be wired or wireless, and different than shown. The flasher may merely may the reflector/light 250 blink, or there may be more specific control to flash or display a certain pattern, color, brightness, etc. The lights may be standard vehicle light bulbs, halogen bulbs, LED bulbs, multi-color bulbs, just to name a few non-limiting possibilities.

### Example Process

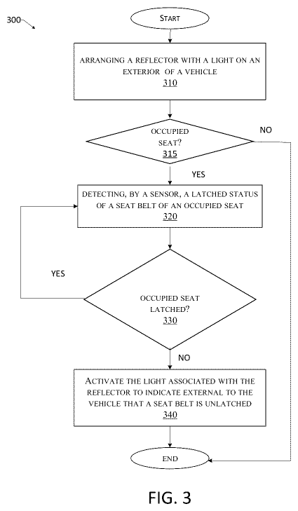

FIG. 3 is a flowchart providing a non-limiting example of the operation of a seat belt detection device according to an illustrative embodiment of the present disclosure. FIG. 3 is shown as a collection of blocks, in a logical order, which represents a sequence of operations that can be implemented in hardware, software, or a combination of hardware and software. In the case of software, the blocks may represent computer-executable instructions that, when executed by a processor(s), perform the illustrated operations. Computer-executable instructions may include, for example, routines, programs, objects, components, data structures, and the like that perform functions. The order in which the operations are described is not to be construed as a limitation, and any number of the described blocks can be combined in any order and/or performed in parallel to implement the process.

At operation 310, a reflector is arranged with a light on a rear portion of a vehicle. It is to be understood that operation 310 is optional, as an existing reflector/light of a vehicle may be used/

At operation 315, when there is a passenger or operator sitting, a seat sensor (such as the seat sensor 240 shown in FIG/2) detects the presence of an occupant. If there is no occupant sensed on the seat, the method ends, and may be periodically repeated, or repeated based on the opening of a vehicle door, etc.

When an occupant is detected on the seat in operation 315, at operation 320 there is a detection as to whether the seat belt is latched. For example, a sensor such as a latch sensor (sensor 235 shown in FIG. 2) may be polled as its status (latched, unlatched). Instead of periodic polling, the latch sensor may be configured to receive a signal from the controller 230 or the seat sensor 240 that someone is occupying the seat.

At operation 330, the latch status is reported to the controller. For example, the latch sensor may be periodically polled or may periodically report status in the event the occupant disconnects the seat belt. Alternatively, the sensing of an opening or a closing of the door may trigger polling of the latch status. In addition, the starting of the vehicle, or putting the car into a drive or reverse, may trigger a polling of the latched status of the seatbelts of occupied seats.

At operation 340, the controller may activate the light associated with the reflector/light to externally indicate from the vehicle that a seatbelt associated with a seated occupant is unlatched. The process may then end until such time that a seat belt is unlatched, a door opened, etc.

It is to be understood that the claimed subject matter is limited to the operations as described above for illustrative purposes. For example, an interior light may be flashed or illuminate the vehicle in a particular color to indicate to law enforcement that a seatbelt of a vehicle occupant is unlatched.

In addition to being controlling the monitoring of seat belt wearing, the controller 230 may receive instructions/controls via a smartphone using Wi-Fi, Bluetooth, near-field communication, Wibro, WiMAX, etc. There may also be a table in a smartphone application or in a server that provides individualized instructions to the controller 230. The vehicle port used for maintenance may also be used to provide updates to the controller 230.

### CONCLUSION

The descriptions of the various embodiments of the disinfecting catheter according to present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The components, operations, steps, features, objects, benefits, and advantages that have been discussed herein are merely illustrative. None of them, nor the discussions relating to them, are intended to limit the scope of protection. While various advantages have been discussed herein, it will be understood that not all embodiments necessarily include all advantages. Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

Numerous other embodiments of the disclosure are also contemplated. There are also embodiments of the disclosure in which the components and/or operations are arranged and/or ordered differently than described and shown herein.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any such actual relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

What is claimed is:

1. A seat belt detection device comprising:
a sensor that detects a latched status of a seat belt of an occupied seat;
a reflector arranged approximate to a rear of a vehicle; and
a light built in the reflector, the light is configured to flash when the sensor outputs detection of an unlatched seat belt is associated with an occupied seat.

2. A seat belt detection device, comprising:
a first sensor configured to detect whether a seat housed in a vehicle is occupied;
a second sensor configured to detect whether a seat belt associated with the seat is latched; and
an indicator that is visible externally from the vehicle;
a controller communicatively coupled to the first sensor, the second sensor, and the indicator, wherein the controller includes circuitry configured to activate the indicator when an occupied seat has an unlatched seat belt.

3. The seat belt detection device according to claim 2, wherein the second sensor is configured to detect whether the seat belt associated with the seat is latched in response to the first sensor detecting the seat is occupied.

4. The seat belt detection device according to claim 2, where the first sensor comprises a switch arranged in the seat.

5. The seat belt detection device according to claim 2, wherein at least one of the first sensor and/or the second sensor comprises an optical sensor.

6. The seat belt detection device according to claim 2, wherein the indicator comprises a light within the vehicle that is externally visible.

7. The seat belt detection device according to claim 2, wherein the indicator comprises a light arranged in or on an external surface of the vehicle.

8. The seat belt detection device according to claim 2, wherein the indicator comprises an existing exterior light of the vehicle.

9. The seat belt detection device according to claim 8, wherein the existing exterior light is configured to provide an indication of the unlatched seat belt selected from the group consisting of a brighter output, a flashing output, a change in color, a change in a flashing pattern, or a strobe output.

10. The seat belt detection device according to claim 2, wherein the indicator comprises an interior light of the vehicle, and wherein the controller is configured to flash the interior light on and off when an occupied seat has an unlatched seat belt.

11. The seat belt detection device according to claim 2, wherein the indicator comprises a light selected from the group consisting of a brake light, a turn-signal light, a hazard light, a license plate light, or a fog light.

12. The seat belt detection device according to claim 2, where the controller is communicatively coupled to the indicator and the first sensor and/or the second sensor by a wireless protocol.

13. A method of detecting seat belt wearing, comprising:
detecting, by a sensor, a latched status of a seat belt of an occupied seat;
arranging a reflector with a light on an external area of a vehicle; and
configuring the light to flash when the sensor detects the seat belt is unlatched in an occupied seat.

14. The method according to claim 13, further comprising
configuring a first sensor to detect whether a seat housed in a vehicle is occupied;
configuring a second sensor to detect whether a seat belt associated with the seat is latched; and
arranging an indicator that is visible externally from the vehicle;
communicatively coupling a controller to the first sensor, the second sensor, and the indicator, and activating, by the controller, the indicator when an occupied seat has an unlatched seat belt.

15. The method according to claim 14, further comprising configuring the second sensor to detect whether the seat belt associated with the seat is latched in response to the first sensor detecting the seat is occupied.

16. The method according to claim 14, further comprising arranging the first sensor in the seat.

17. The method according to claim 14, wherein the arranging of the indicator comprises arranging a light within the vehicle that is externally visible.

18. The method according to claim 14, wherein arranging of the indicator comprises arranging a light in or on the external area of the vehicle.

19. The method according to claim 14, wherein the indicator comprises an existing exterior light of the vehicle.

20. The method according to claim 14, further comprising configuring the existing exterior light to provide an indication of the unlatched seat belt selected from the group consisting of a brighter output, a flashing output, a change in color, a change in a flashing pattern, or a strobe output.

20. The method according to claim 18, further comprising coupling the controller to the indicator, the first sensor and/or the second sensor by a wireless protocol.
